(19) United States
(12) Patent Application Publication
(10) Pub. No.: US 2024/0028990 A1
(43) Pub. Date: Jan. 25, 2024

(54) MULTI-DEPOT VEHICLE SCHEDULING

(71) Applicant: SWVL Global FZE, Dubai (AE)

(72) Inventors: Hoda Hisham Mohamed Rafik Khaled Hamdy, Cairo (EG); Bassem Hossam El Deen Beshir Abbass, Cairo (EG); Ismail Mahmoud Ismail El-Toukhy, Qalubeia (EG); Ali Wagdy Mohamed, Giza (EG)

(21) Appl. No.: 18/225,464

(22) Filed: Jul. 24, 2023

Related U.S. Application Data
(60) Provisional application No. 63/391,931, filed on Jul. 25, 2022.

(51) Int. Cl. G06Q 10/0631; G06Q 50/30

(52) U.S. Cl. CPC G06Q 10/06313; G06Q 10/063118; G06Q 50/30

(57) ABSTRACT

Multi-depot vehicle scheduling in a transportation system may include retrieving vehicle data associated with a set of vehicles and trip data associated with a set of trips, constructing an initial network graph that includes: a respective node for each of the set of trips and each of the set of garages, and a respective edge between each pair of nodes that satisfies schedule constraints related to trip parameters indicated in the trip data, partitioning the initial network graph into a plurality of partitions, that each include respective portions of the initial network graph corresponding to a subsets of the set of vehicles the set of trips, processing each partition of the plurality of partitions separately from other partitions, where processing each partition may comprise, for a given vehicle of the partition, generating a transportation plan that includes a sequence of trips satisfying plan constraints and optimizing an objective function.

The present disclosure claims priority to U.S. Provisional Patent Application No. 63/391,931 entitled “SYSTEMS AND METHODS FOR MULTI-DEPOT VEHICLE SCHEDULING” that was filed on Jul. 25, 2022, and is incorporated herein by reference in its entirety.

### BACKGROUND

### Field

In the logistics industry, transportation systems typically operate a fleet of vehicles to serve the transportation and/or logistical needs of their customers. To keep up with rapidly evolving and diverse requirements of their customers, transportation service providers increasingly rely on technology to optimize the efficiency, profitability, and reliability of their services and to ensure the satisfaction of their customers and employees (e.g., drivers). As the populations of cities and societies continue to increase, transportation systems serving these populations may also need to continuously increase the numbers and types of vehicles in their fleet, as well as the depots or garages where their vehicles are based. More generally, the problem of optimizing vehicle scheduling in transportation systems is a well-known assignment problem that is the subject of extensive research. Over the past few decades, various data modeling and optimization algorithms were proposed to solve several variations of this problem, such as single-depot (SD-VSP) vehicle scheduling problems (where all the vehicles are supplied from a single depot) and multiple depot (MD-VSP) scheduling problems.

However, for many real world applications and in most large-scale transportation networks, these traditional theoretical solutions may be either impractical or may not sufficiently account for some important requirements of the transportation system. For example, in a large-scale transportation network that serves hundreds or thousands of transportation requests every day, implementing and executing a traditional MD-VSP solution may require hours or days of computing and/or a huge amount of processing or memory resources associated with high costs. In technical terms, many existing algorithms classify MD-VSP problems as NP-hard problems, which generally means that the algorithm requires a nondeterministic polynomial period of time to solve the problem. In other words, increasing the size of the transportation network and/or the vehicle fleet significantly increases the computational complexity of solving the problem using these algorithms.

### SUMMARY

Example systems, methods, and apparatus are disclosed herein that enable optimization of vehicle scheduling in a multi-depot transportation system with significantly improved computational performance and operational capabilities.

In an example, a method for scheduling vehicles in a transportation system comprises retrieving vehicle data associated with a set of vehicles and trip data associated with a set of trips. The method also comprises constructing an initial network graph that includes: (i) a respective node for each of the set of trips and each of the set of garages, and (ii) a respective edge between each pair of nodes that satisfy a set of schedule constraints related to trip parameters indicated in the trip data. The method also comprises partitioning the initial network graph into a plurality of partitions. Each partition includes a respective portion of the initial network graph that corresponds to a subset of the set of vehicles and a subset of the set of trips. The method also comprises processing each partition of the plurality of partitions separately from other partitions. Processing each partition may comprise, for a given vehicle of the partition, generating a transportation plan that includes a sequence of trips satisfying a set of plan constraints.

Additional features, advantages, and examples are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not necessarily include all of the advantages and/or aspects listed herein. Thus, the present disclosure expressly contemplates claiming individual and/or various combinations of the aspects and/or advantageous embodiments described herein. Moreover, it should be noted that the language used in the specification has been selected principally for readability and instructional purposes, and not to limit the scope of the inventive subject matter.

### BRIEF DESCRIPTION OF THE FIGURES

FIG. 1 is a diagram of a vehicle scheduling system, according to an example embodiment of the present disclosure.

FIG. 2 is a flowchart of a process performed by a vehicle scheduling system, according to an example embodiment of the present disclosure.

FIG. 3 is a conceptual illustration of a multilayer network graph, according to an example embodiment of the present disclosure.

FIG. 4 illustrates a computing device, as may be used for multi-vehicle depot scheduling, according to embodiments of the present disclosure.

### DETAILED DESCRIPTION OF EXAMPLE EMBODIMENTS

Example systems, methods, and apparatus are disclosed herein that enable optimization of vehicle scheduling in a multi-depot transportation system with significantly improved computational performance and operational capabilities.

Some example implementations provided herein may include a vehicle scheduling computing system configured to access large datasets storing vehicle data, trip data, and/or other relevant inputs (e.g., constraint rules, objective optimization rules, etc.) needed for the vehicle scheduling computing system to process the vehicle and trip data and generate transportation plans for a set of vehicles, such that each transportation plan includes a unique sequence of trips selected to optimize one or more specific objectives of a real-life vehicle scheduling application.

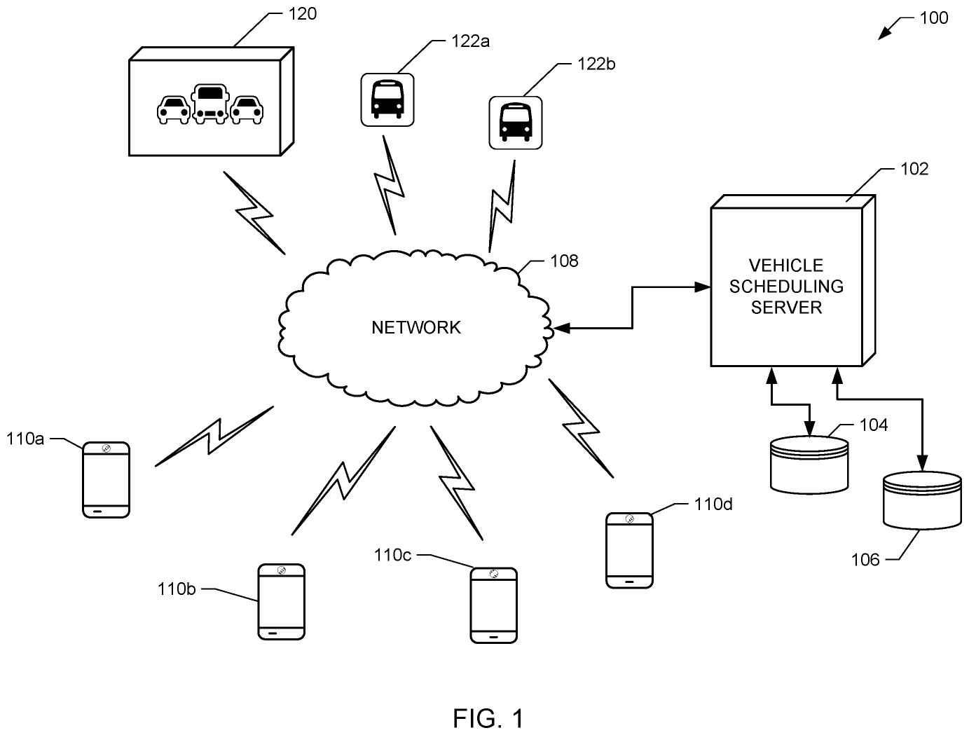

FIG. 1 shows a diagram of an example transportation system 100, according to an example embodiment of the present disclosure. In the illustrated example, the vehicle scheduling system 100 is implemented as a computing system that includes a vehicle scheduling server 102 communicatively coupled (via a network 108) to one or more one or more computing devices exemplified by devices 110a, 110b, 110c, 110d (collectively referred to herein as user devices 110), one or more garage servers exemplified by garage server 120, and one or more vehicles exemplified by vehicles 122a, 122b (collectively referred to as vehicles 122). The system 100 also includes one or more memory devices 106, 108.

The servers 102, 120, the user devices 110, and the vehicles 122 may each include one or more processors, such as single core processors, multi-core processors, etc., and a memory (e.g., memory devices 106, 108, etc.) storing instructions executable by the one or more processors to perform one or more of the functions described in the present disclosure.

In examples, the vehicle scheduling server 102 receives, accesses, and/or compiles trip data about a set of trips or transportation requests and vehicle data about a set of vehicles (e.g., vehicles 122) available for scheduling the set of trips. Each vehicle may be assigned to one of a set of garages (e.g., garage 120) or other type of supply depot at which the vehicle is based. In some examples, although FIG. 1 shows only one garage 120 by way of example, the transportation system 100 alternatively includes more than one supply depot or garage 120.

In examples, the vehicle scheduling server 102 may be configured to use the vehicle and trip data to construct a combined data model such as a network graph, in which each garage and trip is represented (e.g., as a node in the network graph) as well as each possible connection between two nodes (e.g., as an edge in the network graph). For example, the vehicle scheduling server 102 may exclude edges that do not satisfy a set of schedule constraints (e.g., time difference between two trips), which are indicated by trip parameters in the trip data (e.g., trip start time, trip end time, trip start location, trip end location). For example, if there is insufficient time to perform a particular sequence of two trips due to their requested start/end times and/or start/end locations, then an edge between two nodes corresponding to these two trips is removed or excluded from the network graph.

The vehicle scheduling server 102 may also apply other sets of constraints and/or graph size reduction processes to further reduce the size of the graph that will be used to solve the optimization problem. For example, the server 102 may remove edges that do not satisfy dead distance or idle time constraints (e.g., where the distance or driving time between two consecutive trips is more than a threshold, etc.), among other examples. As another example, the vehicle scheduling server 102 may generate a vehicle-specific sub-network graph for each vehicle, corresponding to a filtered copy or version of the initial network graph that excludes edges and/or nodes that do not satisfy a set of vehicle constraints (e.g., vehicle capacity, available working times of drivers for scheduling the vehicle, etc.). Edges and/or nodes that are not specific to the vehicle can then be removed from the sub-network graph. As another example, the vehicle scheduling server 102 may partition the initial network graph into multiple partitions, where each partition includes a portion of the network graph corresponding to just a subset of the vehicles and the trips. Each partition may then be processed separately and/or simultaneously, for example, by executing multiple instances of an optimization algorithm in parallel for each partition to optimize one or more objectives based on just the data in the partition. Several example partitioning processes will be described in greater detail for minimizing potential losses in optimality associated with partitioning.

In one example configuration, given a set of trips (T) as well as a set of supply vehicles (S), the vehicle scheduling server 102 may be configured to find the best assignment of trips to vehicles according to a specific combination of constraints and objectives, which may be defined by a user or operator of the system 100 to include, for example:
(Model Constraint) Each trip should be assigned to at most one vehicle;
(Compatibility Constraint) Each vehicle performs a valid plan (sequence of trips);
(Vehicle Constraint) Each vehicle must start from its garage and return to it after finishing the plan;
Some additional operational constraints are to be satisfied;
A particular objective function should be optimized (maximized or minimized).

In this example, to solve the problem optimally, some information about each trip may be retrieved (e.g., from data storage 104, 106) and/or input, such as start and end location (e.g., latitude, longitude), start time (st), end time (et), estimated demand, estimated revenue, distance and/or duration between any feasible pair of consecutive trips, etc. For vehicles, certain vehicle data may be similarly provided or retrieved, such as garage locations, drivers (also referred to herein as “captains”) working hours, and/or vehicle capacities.

As mentioned above, some additional operational constraints may also be requested and/or included, for example, so that the vehicle scheduling server 102 may generate transportation plans expected to satisfy the captains, such as for example:
Max distance between first and last rides;
Min/Max total plan kilometers;
Min/Max total plan duration; and/or
Max total plan dead kilometers.

In some examples, the vehicle scheduling server 102 may also be configured to vary constraints values of a specific generated transportation plan of a specific vehicle and/or captain (i.e., driver) depending on the number of trips in that particular plan. Example formulations of these constraints will be discussed in greater detail in exemplary embodiments below. In an example, the server 102 may be configured to compute an optimal solution for this problem (e.g., an optimal assignment of trips in each transportation plan) based on some predefined objective function, which may be optionally customized by an operator or user of the system 100. A non-limiting example list of possible objectives that the system 100 may allow a user to select in accordance with some examples herein, includes one or more of:
Maximizing total revenue;
Maximizing total profit;
Minimizing total cost;
Maximizing covered demand;
Maximizing number of assigned trips;
Minimizing/Maximizing number of generated plans;
Maximizing asset utilization (number of trips per plan);
Minimizing total dead kilometers; and/or
Balancing captain (i.e., driver) earnings.

In some scenarios, one or more of these objectives may be selected that conflict with each other. In these examples, the system 100 and/or the vehicle scheduling server 102 may be configured to balance between the optimality associated with the selected combination of objectives.

To facilitate this, in one example, the system 100 may determine an objective function based on a weighted sum of the selected objectives, where a weight of each objective is indicative of its priority (which may optionally be identified by the user or automatically assigned by the system 100).

In another example (e.g., Hierarchical/Lexicographical approach), the system 100 may be configured to optimize the selected objectives in a priority order such that each current objective being optimized does not deteriorate the optimal value of the previous optimized objective (which has a higher priority) by no more than a given tolerance (e.g., 0˜5%).

In some examples, the system 100 and/or the server 102 may be configured to adjust the vehicle scheduling process described above based on a type of transportation service for which the example vehicle scheduling process of the present disclosure is implemented.

In a first example (e.g., retail application), the system 100 may be configured to generate a set of plans compatible with working hours of captains (e.g., drivers) so that each captain may choose one of the available plans. In this example, the system 100 may implement additional constraints to exclude the possibility of generating plans (i.e., sequences of trips) that are not compatible with any of the drivers.

In a second example, the system 100 may alternatively optimize the generated transportation plans without confirming whether a suitable supply (captains) would be available. Advantageously, in this example, areas in the transportation network with high demand for trips and/or shortage of supply can be identified by identifying the transfer plans that were unmatched (e.g., in hindsight).

In a third example (Transportation as a Service or “TaaS”), the system 100 may be configured to generate transportation plans in TaaS type of application, such as a transportation service offered to corporations to help them transport their employees from home to work and vice versa. In this example, the system 100 may be configured to ensure that all demand (e.g., trips to transport all of the client's employees) is satisfied. To facilitate this, one or more of the constraints used to generate plans in the two other examples above may be omitted when generating plans in this example. Additionally or alternatively, one or more optional constraints may be enforced for this example type of transportation system, such as a constraint that balances between captains' earnings across all the generated transportation plans (e.g., which may be more suitable for some corporations that want to share the work evenly among their own dedicated captains).

In a fourth example (Cross-dispatch application), a user may prefer generating transportation plans that rely on existing or previous plans as an additional input and then attempt to update them by adding more rides to optimize the one or more objectives. In this example, the system 100 may be configured to first break down the input plans into single (e.g., preassigned) rides, then combine them with new rides (e.g., indicated by the user) as the initial transportation trips before solving the optimization problem. In some instances, for this type application of the system 100, some additional constraints may be enforced by the system 100 to ensure that all preassigned rides must remain assigned to the same transportation plan of a given captain.

The memory devices 106, 108 can be used to store vehicle data, trip data, type or category of optimization problem, constraint settings, objective optimization settings, and/or any other parameters for customizing the process of generating the transportation plans to optimize one or more objectives, in line with the discussion above. The memory devices 106, 108 may additionally or alternatively include program instructions executable by one or more processors of any of the server 102, the server 120, the vehicles 122, and/or the user device 110 to perform one or more of the functions described above. To that end, the memory devices 106 and 108 may include any computer-readable medium, such as random access memory (“RAM”), read only memory (“ROM”), flash memory, magnetic or optical disks, optical memory, or other storage media.

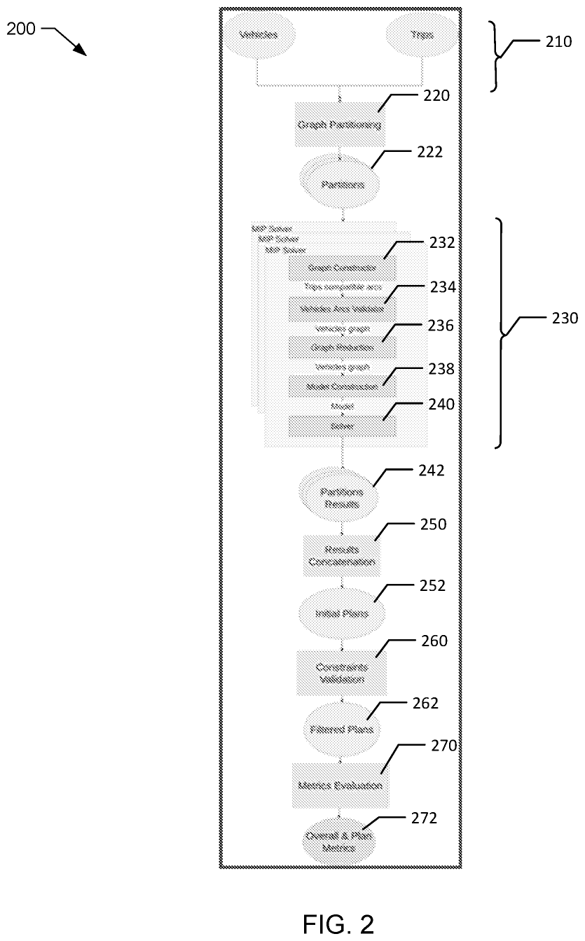

FIG. 2 is a flowchart of an example process 200 which may be implemented by a vehicle scheduling system or a transportation system such as the transportation system 100 of FIG. 1, according to an example embodiment of the present disclosure. For example, the process 200 represented in FIG. 2 may represent an algorithm (e.g., program instructions stored on a memory, etc.) executed by one or more processors of the server 102, the server 120, the user devices 110, and/or the vehicles 122, to perform one or more of the functions of the process 200 described below.

The process 200 involves (at block 210) constructing an initial network graph based on vehicle data and trip data. The vehicle data and trip data, for example, may be retrieved from data storage such as data storage 104, 106 of the system 100. In some examples, the initial network graph includes: (i) a respective node for each of the set of trips and each of the set of garages, and (ii) a respective edge between each pair of nodes that satisfy a set of schedule constraints related to trip parameters indicated in the trip data.

In some examples, the process 200 may involve partitioning (block 220) the initial network graph into smaller partitions (block 222) and solving them in parallel then combining the results. In these examples, significant improvements in computational resource requirements, especially for large data sets (e.g., hundreds or thousands of trips or more). However, some optimality may be lost (e.g., tradeoff between computational time requirement and optimality). In some examples, the loss in optimality may be less significant (e.g., due to large number of connections between trips, i.e., a trip can be reached by multiple paths) than the improvement in computational resource overhead based on the partitioning processes disclosed herein.

In some examples, partitioning (block 220) is done by first constructing the initial graph (block 210) as mentioned above, then the process 200 proceeds with partitioning (block 220) the initial network graph into multiple partitions (222). In some examples, the number of partitions may be automatically determined based on a size of the vehicle data and/or trip data, and/or selected by a user of the system 100. Below are example processes that may be included in the partitioning (block 220) process in accordance with the present disclosure, while also mitigating potential losses to optimality:
Using minimum cut algorithm (e.g., to limit number of lost connections or edges);
Increasing the weight of edges connected to garage nodes, in order not to be removed and hence not losing the vehicle ability to do rides;
Balancing between partitions in terms of number of trips and number of vehicles. It is not desirable to have a partition with so many trips and very low number of vehicles or vice versa. The ideal situation is to distribute trips evenly among all partitions and the same for vehicles; and/or
Balancing between time buckets across all partitions in terms of number of trips. For example, in some scenarios, an unbalanced partition may end up including many trips in the morning (e.g., “first time bucket”) as well as the evening (e.g., “third time bucket”) but almost no trips in the middle of the day (e.g., “second time bucket”). For example, without violating dead time constraints, it may not be possible to stitch morning trips directly with evening trips in many transportation plans, which may result in system 100 generating a very low number of covered trips. To mitigate this possibly unbalanced partitioning scenario, the process 200 may involve determining multiple time buckets corresponding to different times-of-day (e.g., morning, afternoon, evening, etc.). Then, for each time bucket, the partitioning (at block 220) may involve balancing the partitions by distributing the trips in the same time bucket (e.g., trips that are in the morning, etc.) evenly (or substantially evenly) across all (or most) of the partitions (at block 222). Although this example (balancing by time buckets) is generally a heuristic process that does not necessarily produce better results in all types of data sets, it may be suitable for some types of data sets (e.g., large data sets) and may improve optimality versus a partitioning process that does not perform this type of balancing (based on time buckets).

In some scenarios, one or more of the three partitioning processes described above may conflict with each other when doing the partitioning (block 220). Therefore, in some examples, one or more of these partitioning processes can be prioritized to try to achieve, at least partially, one or more of the benefits associated with balancing the partitions in terms of the above-mentioned factors.

In an example, the initial network graph can be generated without including vehicle data (i.e., based on trip data); and then the first partitioning technique can be applied (i.e., using the minimum cut algorithm) so as to select the trips in each partition which would minimize the number of edges lost due to the partitioning. In another example, the initial network graph can be generated to include the vehicles (i.e., garage locations as nodes), and then a combination of the second and third partitioning processes (e.g., weight edges and balancing in terms of numbers of vehicles and trips) can then be applied to partition the initial graph. Other examples are possible as well.

In general, whether or not partitioning (220) is employed, the graph construction method of process 200 may include one or more of the following sub-processes: Valid arcs generation; Vehicle arcs filtration; and/or Graph reduction.

For example, an initial network graph may be constructed (block 210) which represents the possible connections between trips. Each trip is represented by one node and for each possible connection (i.e., two trips that can be done sequentially on time without violating schedule constraints such as dead distance constraints, time difference constraints, etc.), a new valid arc is created in the graph between these two nodes. Further, after initial valid arcs or edges (block 210 and/or block 232) in the initial network graph are created, a vehicle-specific sub-network graph may then be created in which edges incompatible with vehicle constraints (e.g., vehicle capacity, working hours of vehicle, etc.) are filtered out (block 234) in the sub-network graph of that specific vehicle, so that the vehicle is assigned to only a subset of the arcs (i.e., edges) of the initial network graph depending on vehicle parameters such as capacity, velocity, and/or captains' working hours, etc. In one example, the vehicle-specific sub-network graphs generated (block 234) may correspond to a filtered copy of the initial network graph excluding vehicle-invalid arcs or edges of that specific vehicle.

In an example, the process 200 may also optionally further reduce (block 236) the graph size for each vehicle so as to decrease the model size and hence the solving time. For instance, there may be some nodes (trips) in a vehicle-specific sub-network graph that cannot be reached from the garage or the garage cannot be reached from it (e.g., a node cannot exist on a closed path starting from and ending at the garage while complying with the constraints, etc.). In this example, those unreachable nodes may also be removed (block 236) from the graph since there is no possible (direct or indirect) path from the garage node to it or vice versa. In some scenarios, many nodes may be removed (at block 236) from vehicle-specific sub-network graphs, for example, where all preassigned trips must be assigned to the same vehicle (e.g., cross-dispatch use case). In such scenarios, the process 200 at block 236 may involve removing all nodes that cannot be reached between any pair of consecutive preassigned trips nodes using the same logic.

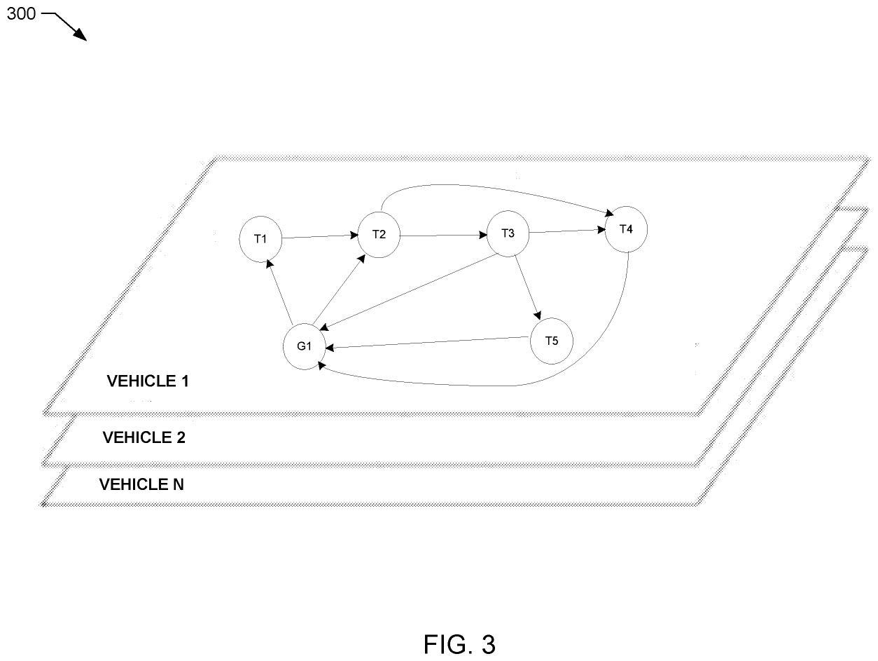

In some examples, the vehicle-specific network graphs may correspond to a multilayer network graph. By way of example, FIG. 3 shows a multilayer network graph data model implementation that represents the vehicle-specific network graphs (e.g., as N separate layers for N vehicles), which may be generated by filtering an initial network graph that includes all the trips such that each layer includes just a subset of the complete sets of trips (e.g., nodes) in the initial network graph.

At block 238, after constructing a graph for each vehicle, the process 200 may involve using the remaining graph arcs (i.e., edges connecting nodes) of each vehicle-specific network graph to represent decision variables in the optimization problem solver data model. Further, in some examples, constraints and objective functions may be represented using these decision variables as we will discuss below.

The results (block 242) from each instance of the optimization solver algorithm that was executed for each partition (block 230) can then be concatenated (block 250) to generate a set of initial transportation plans (252). As noted above, each transportation plan is specific to a vehicle and includes a sequence of trips assigned for a specific vehicle. In some examples, process 200 may involve reviewing and/or filtering (at block 260) the initial transportation plans (i.e., after the results from all the partitions are concatenated at block 250) to ensure that all constraints are still satisfied. The filtered transportation plans (262) may then be optionally used to perform metrics evaluation (at block 270), for example, to assess (block 272) the actual optimality of the objectives and/or perform other analysis. For example, the process 200 may optionally involve detecting areas of supply shortage (e.g., not enough drivers or vehicles) and/or excess demand (e.g., too many trips requested in this geographic area), etc., in the transportation system.

Another example implementation of the process 200 including a description of additional possible example aspects will now be described below.

In this example, the process 200 Each trip or supply depot is represented as a node in the network with a given index as indicated by equation (1) below:

$$For i = 1 , 2 , … , \vert T \vert + \vert S \vert : \\ N = \{ \begin{matrix}Trip , if i \leq \vert T \vert \\ Supply Depot , if i > \vert T \vert\end{matrix} \qquad ( 1 )$$

For each possible connection between nodes i,j, an edge or arc (i,j) may then be added if it satisfies one or more of following the compatibility constraints (see equation (2)):
city compatibility;
type and category compatibility;
within maximum dead and idle time threshold;
buffer time to catch the next ride;
within maximum dead distance between rides; and/or
vehicle k Compatibility: (e.g., demand fits in bus capacity, captain availability—start & end work time)

∀k=1,2, . . . ,|S|: A^{k}={(i,j)|compatible^{k}_{i,j},‡i,j=1,2, . . . ,|T|+|S|} (2)
Next, the process 200 at block 238 involves assigning a decision variable x^{k}_{i,j} for each valid arc in the vehicle-specific graph, as indicated in equation (3) below:

$${x}_{i , j}^{k} = \{ \begin{matrix}1 , if node j is assigned after node i to vehicle k \\ ∀ ( i , j ) ∈ {A}^{k} , k \leq \vert S \vert \\ 0 , otherwise\end{matrix} \qquad ( 3 )$$

The model construction step at block 238 may also involve defining a multi-objective function to be optimized by the solver (at block 240) so as to provide a solution that is aligned with one or more desired business goals and/or metrics. Equation (4) below shows an example profit or optimization function formulation to be solved by the solver at block 240:

Profit=max Σₖ₌₁^{|S|}Σ_{(i,j)∈A}_{^{k}}(rvⱼ−c_{i,j}^{k})x_{i,j}^{k} (4)

In some examples, the revenue (rv) in equation (4) may be calculated from the expected demand on the schedule while cost (c) calculation can vary between categories but usually includes costs of operation based on duration & distance traveled. Other examples are possible.

Although many of the schedule and vehicle constraints are handled by ensuring the compatibility of generated arcs in the network (at blocks 232 and 234), in some examples, there may be other types of constraints that are added to the model to guarantee an acceptable valid solution.

For example, model correctness constraints may be included (at block 238) to the data model before executing the solver algorithm (at block 240).

Flow conservation constraints (equation 5) for example, are constraints that could be added to ensure flow correctness at each node in the network.

$$∀ k \leq \vert S \vert , i \leq \vert N \vert : {\sum }_{j : ( i , j ) ∈ {A}^{k}} {x}_{i , j}^{k} - {\sum }_{j : ( j , i ) ∈ {A}^{k}} {x}_{j , i}^{k} = 0 \qquad ( 5 )$$

One assign constraints (Equation (6)) may be added to ensure that each trip is assigned to at most one vehicle:

∀i≤|N|: Σₖ^{|S|}Σ_{ir(i,j)∈A}_{^{k}}x_{i,j}^{k}≤1 (6)

Plan-level constraints (equations 7-9) may also be added. In some scenarios, the formulations above of equations 7-9 for plan-level constraints may be less suitable, for example, if some vehicles are unable to satisfy a “minimum” constraint value. For example, if a minimum plan rides constraint is 4 and there is a vehicle in the fleet that can only perform 3 rides, that vehicle may not be assigned any rides to satisfy the constraint. However, if another constraint requires that each vehicle must perform at least 3 rides, then it may conflict with the minimum plan rides constraints. To accommodate both constraints, equation 10 below can be added to the model to selectively enable such vehicles to be free:

Plan Duration Constraints:

∀k≤|S|: min plan dur.≤Σ_{ir(i,k+|T|)∈A}_{^{k}}x_{i,k+|T|}^{k}*etᵢ−Σ_{ir(k+|T|,i)∈A}_{^{k}}x_{k+|T|,i}^{k}*stᵢ≤max plan dur. (7)

Plan Kms Constraints:

∀k≤|S|: min plan km≤Σ_{(i,j)∈A}_{^{k}}_{,j<|T|}x_{i,j}^{k}*trip kmⱼ≤max plan km (8)

Number of Tides Constraints:

∀k≤|S|: min plan rides≤Σ_{(i,j)∈A}_{^{k}}_{,j<|T|}x_{i,j}^{k}≤max plan rides (9)

hasRides^{k}=Σ_{ir(i,k+|T|)∈A}_{^{k}}x_{i,k+|T|}^{k} (10)

For example, the constraint of equation 10 may correspond to a binary model that evaluates to a value of either 0 or 1, so it can be used as a Boolean value to indicate whether a vehicle could actually perform rides while satisfying the minimum value constraints or not. Thus, for example, the minimum plan rides constraint of equation (9) can be reformulated as follows:

∀k≤|S|: min plan rides*hasRides^{k}≤Σ_{(i,j)∈A}_{^{k}}x_{i,j}^{k}≤max plan rides (11)

Other example constraints that could be enforced by the system 100 are also possible, which can be selectively (e.g., based on user selection) enforced for certain applications. For example, “must assign” and “time-slot” constraints can be added for cross-dispatch applications (e.g., where the transportation system needs to ensure that certain drivers perform certain trips, etc.).

Equation (12) below shows a formulation of an example must assign constraint (where a plan of a vehicle must include certain pre-assigned trips):

∀k≤|S|: Σ_{ir(i,p)∈A}_{^{k}}x_{i,p}^{k}=hasRides^{k},p∈P^{k} (12)

Equations 13-15 show example time-slot constraints (e.g., before, between, or after a pre-assigned trip, etc.):

Before First Pre-Assigned Trips:

∀k≤|S|: Σ_{ir(i,p}_{_{first}}_{)∈A}_{^{k}}x_{i,p}_{_{first}}^{k}=hasRides^{k} (13)

Between Pre-Assigned Trips:

∀k≤|S|: Σ_{ir(p,i)∈A}_{^{k}}x_{p,i}^{k}=hasRides^{k},p∈P^{k} & p≠pₗₐₛₜ (14)

After Last Pre-Assigned Trip:

∀k≤|S|: Σᵢᵣ₍ₚ_{ₗₐₛₜ}_{,i)∈A}_{^{k}}xₚ_{ₗₐₛₜ}_{,i}^{k}=hasRides^{k} (15)

Where p_{first}: pre-assigned trip & pₗₐₛₜ: last pre-assigned trip

As noted above, the process 200 may enable an operator of the system 100 to enforce various different combinations of constraints and to optimize different combinations of objectives, to satisfy the requirements of a particular vehicle scheduling application. In some scenarios, an acceptance rate (e.g., driver satisfaction with their assigned plan, etc.) and/or cost associated with each plan may depend on the number of rides in the plan. For instance, a plan that has five or more rides (e.g., high utility may be associated with a higher acceptance rate by captains (i.e., drivers) due to higher expected earnings compared to a plan that only has two rides. Additionally or alternatively, such a 5+ ride plan may be associated with lower operation costs (e.g., per km or per hour) than a two-ride plan. Accordingly, in some examples, the process 200 may involve applying less restrictive constraints for “high-ride” plans to increase the possibility of generating such plans when the optimization problem is solved. To facilitate this, the process 200 may involve enforcing multi-value constraints.

For example, indicator variables y_{b}^{k} can be introduced in the model to indicate whether a vehicle k has b rides assigned to it in the plan, such that b∈B=maxRides, . . . maxRides, as indicated by equation 16 below.

$${y}_{b}^{k} = \{ \begin{matrix}1 , if vehicle k has b trips \\ 0 , otherwise\end{matrix} \\ ∀ b ∈ B , k \leq \vert S \vert \qquad ( 16 )$$

Additional constraints (see equations 17-18 below) may then be added into the model to ensure corrections associated with such indicator variables (e.g., equation 16) are activated for specific vehicles that meet the indicator variable's condition, such as for example:

$$\begin{matrix}∀ k \leq \vert S \vert : {\sum }_{j : ( i , j ) ∈ {A}^{k}} {x}_{i , j}^{k} = {\sum }_{b ∈ B} b * {y}_{b}^{k} & ( 17 ) \\ ∀ k \leq \vert S \vert : {\sum }_{b ∈ B} {y}_{b}^{k} \leq 1 & ( 18 )\end{matrix}$$

More generally, the example process 200 may involve adding constraints based on a number of rides in a given plan, which can be achieved by changing the right hand side of the formula of a given constraint from a single value to: Σ_{b∈B}y_{b}^{k}*constraintValue_{b}.

For example, the plan distance constraint of equation (8) can be adjusted as follows:

$$∀ k \leq \vert S \vert : {\sum }_{j : ( i , j ) ∈ {A}^{k}} {x}_{i , j}^{k} * trip {km}_{j} \leq {\sum }_{b ∈ B} {y}_{b}^{k} * max plan {km}_{b} \qquad ( 19 )$$

Other constraints, such as any of the plan constraints, etc., described above, can be similarly adjusted to incorporate the y_{b}^{k} indicator.

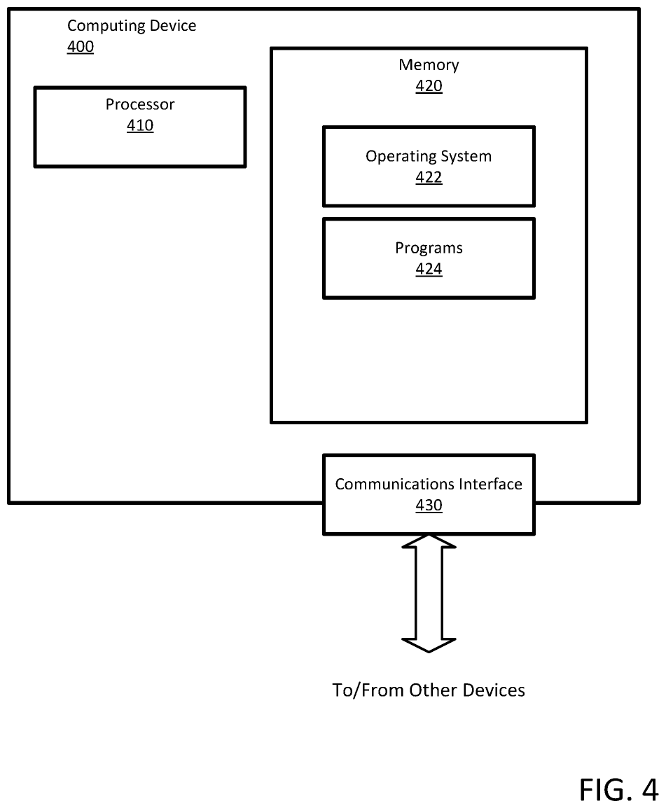

FIG. 4 illustrates a computing device 400, as may be used for multi-vehicle depot scheduling, according to embodiments of the present disclosure. The computing device 400 may include at least one processor 410, a memory 420, and a communication interface 430.

The processor 410 may be any processing unit capable of performing the operations and procedures described in the present disclosure. In various embodiments, the processor 410 can represent a single processor, multiple processors, a processor with multiple cores, and combinations thereof.

The memory 420 is an apparatus that may be either volatile or non-volatile memory and may include RAM, flash, cache, disk drives, and other computer readable memory storage devices. Although shown as a single entity, the memory 420 may be divided into different memory storage elements such as RAM and one or more hard disk drives. As used herein, the memory 420 is an example of a device that includes computer-readable storage media, and is not to be interpreted as transmission media or signals per se.

As shown, the memory 420 includes various instructions that are executable by the processor 410 to provide an operating system 422 to manage various features of the computing device 400 and one or more programs 424 to provide various functionalities to users of the computing device 400, which include one or more of the features and functionalities described in the present disclosure. One of ordinary skill in the relevant art will recognize that different approaches can be taken in selecting or designing a program 424 to perform the operations described herein, including choice of programming language, the operating system 422 used by the computing device 400, and the architecture of the processor 410 and memory 420. Accordingly, the person of ordinary skill in the relevant art will be able to select or design an appropriate program 424 based on the details provided in the present disclosure.

The communication interface 430 facilitates communications between the computing device 400 and other devices, which may also be computing devices as described in relation to FIG. 4. In various embodiments, the communication interface 430 includes antennas for wireless communications and various wired communication ports. The computing device 400 may also include or be in communication, via the communication interface 430, one or more input devices (e.g., a keyboard, mouse, pen, touch input device, etc.) and one or more output devices (e.g., a display, speakers, a printer, etc.).

Although not explicitly shown in FIG. 4, it should be recognized that the computing device 400 may be connected to one or more public and/or private networks via appropriate network connections via the communication interface 430. It will also be recognized that software instructions may also be loaded into the non-transitory computer readable medium 420 from an appropriate storage medium or via wired or wireless means.

Accordingly, the computing device 400 is an example of a system that includes a processor 410 and a memory 420 that includes instructions that (when executed by the processor 410) perform various embodiments of the present disclosure. Similarly, the memory 420 is an apparatus that includes instructions that when executed by a processor 410 perform various embodiments of the present disclosure.

Certain terms are used throughout the description and claims to refer to particular features or components. As one skilled in the art will appreciate, different persons may refer to the same feature or component by different names. This document does not intend to distinguish between components or features that differ in name but not function.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims

The terms “a,” “an,” “the” and similar referents used in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention. The terms “comprise”, “comprises”, “comprised” or “comprising”, “including” or “having” and the like in the present specification and claims are used in an inclusive sense, that is to specify the presence of the stated features but not preclude the presence of additional or further features. It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method for scheduling vehicles in a transportation system, the method comprising:
retrieving vehicle data associated with a set of vehicles and trip data associated with a set of trips, wherein the vehicle data includes, for each vehicle of the set of vehicles, an indication of a garage assigned to the vehicle from a set of garages;
constructing an initial network graph that includes: (i) a respective node for each of the set of trips and each of the set of garages, and (ii) a respective edge between each pair of nodes that satisfy a set of schedule constraints related to trip parameters indicated in the trip data;
partitioning the initial network graph into a plurality of partitions, each partition including a respective portion of the initial network graph that corresponds to a subset of the set of vehicles and a subset of the set of trips; and
processing each partition of the plurality of partitions separately from other partitions, wherein processing each partition comprises, for a given vehicle of the partition, generating a transportation plan that includes a sequence of trips satisfying a set of plan constraints, wherein the sequence of trips begins and ends at a given garage assigned to the given vehicle, and wherein each trip of the partition is included in at most one transportation plan generated using the partition.

2. The method of claim 1, wherein the trip parameters include a start location, an end location, a start time, and an end time.

3. The method of claim 1, wherein processing each partition comprises:
for each vehicle of a given partition, generating a sub-network graph corresponding to a filtered version of the initial network graph of the given partition excluding one or more edges based on the one or more edges failing to satisfy a set of vehicle constraints related to vehicle parameters of the vehicle indicated in the vehicle data.

4. The method of claim 3, wherein the vehicle parameters of the vehicle include: vehicle capacity, and work times associated with one or more drivers available for scheduling the vehicle.

5. The method of claim 3, wherein generating the sub-network graph further comprises:
removing one or more nodes from the sub-network graph that are not connected, directly or indirectly, to a node that represents a garage assigned to the vehicle.

6. The method of claim 1, further comprising:
simultaneously processing each partition of the plurality of partitions separately from each other by executing multiple instances of an algorithm in parallel, each instance configured to process a respective partition of the plurality of partitions and to generate transportation plans for vehicles of the respective partition that optimize one or more objectives.

7. The method of claim 1, wherein the set of plan constraints include one or more of: a minimum plan duration, a maximum plan duration, a minimum plan distance, a maximum plan distance, a minimum number of trips, or a maximum number of trips.

8. The method of claim 7, further comprising:
applying a given plan constraint as a binary variable that corresponds to one of a first value or a second value based on a number of trips in a given transportation plan.

9. The method of claim 7, further comprising:
dynamically adjusting one or more of the set of plan constraints during generation of a given transportation plan based on a number of trips assigned to the given vehicle in the given transportation plan.

10. The method of claim 1, further comprising:
associating the set of trips to a plurality of time buckets based on respective start times of the set of trips,
wherein partitioning the initial network graph comprises balancing a number of trips associated with each time bucket among the plurality of partitions.

11. A system, comprising:
a processor; and
a memory, including instructions that when executed by the processor perform operations including:
retrieving vehicle data associated with a set of vehicles and trip data associated with a set of trips, wherein the vehicle data includes, for each vehicle of the set of vehicles, an indication of a garage assigned to the vehicle from a set of garages;
constructing an initial network graph that includes: (i) a respective node for each of the set of trips and each of the set of garages, and (ii) a respective edge between each pair of nodes that satisfy a set of schedule constraints related to trip parameters indicated in the trip data;
partitioning the initial network graph into a plurality of partitions, each partition including a respective portion of the initial network graph that corresponds to a subset of the set of vehicles and a subset of the set of trips; and
processing each partition of the plurality of partitions separately from other partitions, wherein processing each partition comprises, for a given vehicle of the partition, generating a transportation plan that includes a sequence of trips satisfying a set of plan constraints, wherein the sequence of trips begins and ends at a given garage assigned to the given vehicle, and wherein each trip of the partition is included in at most one transportation plan generated using the partition.

12. The system of claim 11, wherein the trip parameters include a start location, an end location, a start time, and an end time.

13. The system of claim 11, wherein processing each partition comprises:
for each vehicle of a given partition, generating a sub-network graph corresponding to a filtered version of the initial network graph of the given partition excluding one or more edges based on the one or more edges failing to satisfy a set of vehicle constraints related to vehicle parameters of the vehicle indicated in the vehicle data.

14. The system of claim 11, the operations further comprising:
simultaneously processing each partition the plurality of partitions separately from each other by executing multiple instances of an algorithm in parallel, each instance configured to process a respective partition of the plurality of partitions and to generate transportation plans for vehicles of the respective partition that optimize one or more objectives.

15. The system of claim 11, wherein the set of plan constraints include one or more of: a minimum plan duration, a maximum plan duration, a minimum plan distance, a maximum plan distance, a minimum number of trips, or a maximum number of trips.

16. The system of claim 11, the operations further comprising:
associating the set of trips to a plurality of time buckets based on respective start times of the set of trips,
wherein partitioning the initial network graph comprises balancing a number of trips associated with each time bucket among the plurality of partitions.

17. A non-transitory memory storage device, including instructions that when executed by a processor perform operations including:
retrieving vehicle data associated with a set of vehicles and trip data associated with a set of trips, wherein the vehicle data includes, for each vehicle of the set of vehicles, an indication of a garage assigned to the vehicle from a set of garages;
constructing an initial network graph that includes: (i) a respective node for each of the set of trips and each of the set of garages, and (ii) a respective edge between each pair of nodes that satisfy a set of schedule constraints related to trip parameters indicated in the trip data;
partitioning the initial network graph into a plurality of partitions, each partition including a respective portion of the initial network graph that corresponds to a subset of the set of vehicles and a subset of the set of trips; and
processing each partition of the plurality of partitions separately from other partitions, wherein processing each partition comprises, for a given vehicle of the partition, generating a transportation plan that includes a sequence of trips satisfying a set of plan constraints, wherein the sequence of trips begins and ends at a given garage assigned to the given vehicle, and wherein each trip of the partition is included in at most one transportation plan generated using the partition.

18. The non-transitory memory storage device of claim 17, wherein processing each partition comprises:
for each vehicle of a given partition, generating a sub-network graph corresponding to a filtered version of the initial network graph of the given partition excluding one or more edges based on the one or more edges failing to satisfy a set of vehicle constraints related to vehicle parameters of the vehicle indicated in the vehicle data.

19. The non-transitory memory storage device of claim 17, the operations further comprising:
simultaneously processing each partition the plurality of partitions separately from each other by executing multiple instances of an algorithm in parallel, each instance configured to process a respective partition of the plurality of partitions and to generate transportation plans for vehicles of the respective partition that optimize one or more objectives.

20. The non-transitory memory storage device of claim 17, the operations further comprising:
associating the set of trips to a plurality of time buckets based on respective start times of the set of trips,
wherein partitioning the initial network graph comprises balancing a number of trips associated with each time bucket among the plurality of partitions.
